(19) United States
(12) Patent Application Publication
(10) Pub. No.: US 2018/0291216 A1
(43) Pub. Date: Oct. 11, 2018

(54) METALLIC POWDER PIGMENT INK COMPOSITION FOR OIL-BASED MARKING PEN

(71) Applicant: SAKURA COLOR PRODUCTS CORPORATION, Osaka-shi, Osaka (JP)

(72) Inventors: Takayuki KITAGUCHI, Osaka-shi, Osaka (JP); Tomohiro ASOU, Osaka-shi, Osaka (JP)

(21) Appl. No.: 15/756,862

(22) PCT Filed: Aug. 23, 2016
(86) PCT No.: PCT/JP2016/074431

§ 371 Date: Mar. 1, 2018

(30) Foreign Application Priority Data
Sep. 7, 2015 (JP) 2015-176203

(51) Int. Cl. C09D 11/17

(52) U.S. Cl. CPC C09D 11/17

(57) ABSTRACT

The invention provides a metallic powder pigment ink composition for an oil-based marking pen, the ink composition comprising an organic solvent, a metal powder pigment and a combination of a first resin and a second resin, wherein the first resin is at least one selected from a ketone resin, a hydrogenated rosin resin and an ultralight-colored rosin resin and the second resin is at least one second resin selected from an acrylic resin, a styrene-acrylic resin and a styrene-maleic acid resin. The metallic powder pigment ink composition provides a marking improved in glitter.

### TECHNICAL FIELD

The present invention relates to a metallic powder pigment ink composition for an oil-based marking pen, and more particularly, to a metallic powder pigment ink composition for an oil-based marking pen which gives a marking (i.e., a handwriting) with improved glitter.

### BACKGROUND OF THE INVENTION

Various metallic powder pigment ink compositions for marking pens containing a metallic powder pigment such as aluminum powder or brass powder as a pigment have been conventionally known. When a marking is provided on a writing surface using such an ink composition, the metallic powder pigment is fixed on the writing surface together with a resin dissolved in the ink composition, thereby the metallic powder pigment imparts glitter to the marking.

As an example of such a metallic powder pigment ink composition for a marking pen, an ink composition is known which comprises propylene glycol monomethyl ether as an organic solvent and a phenol resin as a resin together with an aluminum powder pigment surface-treated with a fatty acid (salt) (see patent document 1). However, the above-mentioned metallic powder pigment ink composition for a marking pen has problems in storage stability and ink drainability, and hence in smoothness in writing, and in addition, it does not impart satisfactory glitter to the marking.

As such being the case, a metallic powder pigment ink composition for a marking pen which is improved in storage stability and smoothness in writing by making use of a ketone resin as a resin has also been proposed (see patent document 2), but the glitter that a handwriting has still remains not satisfactory.

### PRIOR ART DOCUMENT

### Patent Document

[Patent document 1] JPH4-126782A
[Patent document 2] JPH6-299114A.

### DISCLOSURE OF THE INVENTION

### Problem to be Solved by the Invention

The invention has been made to solve the above-mentioned problems involved in the conventional metallic powder pigment ink composition, and more particularly, to provide a metallic powder pigment ink composition for an oil-based marking pen which imparts improved glitter to a marking.

### Means for Solving Problem

The invention provides a metallic powder pigment ink composition for an oil-based marking pen, the metallic powder pigment ink composition comprising an organic solvent, a metallic powder pigment and resin, wherein the resin is a combination of at least one first resin selected from a ketone resin, a hydrogenated rosin resin and an ultralight-colored rosin resin and at least one second resin selected from an acrylic resin, a styrene-acrylic resin and a styrene-maleic acid resin.

It is particularly preferred hat the metallic powder pigment ink composition for an oil-based marking pens comprises 2 to 30% by weight of the first resin and 0.1 to 15% by weight of the second resin, each based on the weight of the ink composition.

As the metallic powder pigment, an aluminum powder pigment is particularly preferred.

### Effect of the Invention

The metallic powder pigment ink composition for an oil-based marking pen of the invention comprises as resins a combination of at least one first resin selected from a ketone resin, a hydrogenated rosin resin and an ultralight-colored rosin resin and at least one second resin selected from an acrylic resin, a styrene-acrylic resin and a styrene-maleic acid resin, thereby to provide a marking improved in glitter.

### (Organic Solvent)

In the metallic powder pigment ink composition for an oil-based marking pen of the invention, any organic solvent which is conventionally known to be usable as an organic solvent for an oil-based marking pen is used, and at least one selected from an aliphatic alcohol, a glycol, a glycol ether and a glycol ether esters is especially preferred.

Examples of the aliphatic alcohol include, for example, ethyl alcohol, n-propyl alcohol, isopropyl alcohol, n-butyl alcohol, isobutyl alcohol, sec-butyl alcohol, teat-butyl alcohol, tert-amyl alcohol and the like. Examples of the glycol include, for example, ethylene glycol, propylene glycol, diethylene glycol, dipropylene glycol and the like. Examples of the glycol ether include, for example, monomethyl ether, monoethyl ether, monoisopropyl ether, monobutyl ether, monohexyl ether, monophenyl ether, dimethyl ether, and diethyl ether of the glycol, and 3-methyl-3-methoxybutanol, 3-methoxybutanol and the like.

Examples of the glycol ether ester include, for example, an acetic acid ester (acetates) of the glycol ether.

Among the above-mentioned organic solvents, the glycol ethers are preferred. For example, propylene glycol monomethyl ether is one of preferred glycol ethers.

The metallic powder pigment ink composition for an oil-based marking pen of the invention comprises the organic solvent usually in an amount in the range of 50 to 90% by weight, preferably in the range of 60 to 85% by weight, based on the weight of the ink composition.

### (Metallic Powder Pigment)

In the metallic powder pigment ink composition for an oil-based marking pen of the invention, an aluminum powder pigment, a brass powder pigment, a copper powder pigment, a zinc powder pigment, a copper alloy powder pigment and the like are used as the metallic powder pigment. Among the above-mentioned, an aluminum powder pigment or a brass powder pigment is preferably used, and in particular, an aluminum powder pigment is preferably used.

According to the invention, the metallic powder pigment is incorporated usually in an amount in the range of 3 to 40% by weight, preferably in the range of 5 to 30% by weight, based on the weight of the ink composition. When the ink composition comprises the metallic powder pigment in an amount less than 3% by weight, it fails to provide a marking having satisfactory glitter, whereas when the ink composition contains the metallic powder pigment in an amount of more than 40% by weight, it has too high a viscosity, and it also contains an excess amount of a solid content. As a consequence, the ink composition is inferior in smoothness in writing and will become clogged at the pen tip. In particular, according to the invention, the metal powder pigment is preferably used in the range of 6 to 20% by weight based on the weight of the ink composition.

In the metallic powder pigment ink composition for an oil-based marking pen of the invention, the average particle diameter of metal powder pigment used is not particularly limited, but the range from 1 to 30 μm is usually preferred, and the range from 5 to 20 μm is more preferred. In the invention, the average particle diameter of the metal powder pigment used is the average volume diameter as measured by a laser diffraction scattering method.

In the invention, as the aluminum powder pigment, Stapa 15, 20, 30 or 40, Rotovario 506903 Silver, Rotosafe 760013 Silver, Standart Chromal VIII (manufactured by Eckart), Aluminum Paste 1200N, Aluminum Paste 2172YC, Alpaste WXM0660, Alpaste WXM0650 (manufactured by Toyo Aluminum Co., Ltd.), Asahi Kasei Alpaste FW-610, Asahi Kasei Alpaste FW-520B, Asahi Alpaste FW-21G (manufactured by Asahi Kasei Corporation), Astroshine T-8970BC, Astroshine T-8975BC, Astroshine T-8990BC (manufactured by Nihonboshitu Co., Ltd.) are mentioned, for example. However, the aluminum powder pigment used in the invention is not limited to those exemplified above.

Examples of the brass powder pigment used include, for example, Offsetsuper 3000, Rotoflex XA4-209, etc.

In the metallic powder pigment ink composition for an oil-based marking pen of the invention, at least one first resin selected from the ketone resin, the hydrogenated rosin resin and the ultralight-colored rosin resin is used together with at least one second resin selected from the acrylic resin, the styrene-acrylic resin and the styrene-maleic acid resin, and consequently, the metallic powder pigment ink composition provides a marking synergistically improved in glitter.

The metallic powder pigment ink composition for an oil-based marking pen of the invention contains the at least one first resin preferably in an amount in the range of 2 to 30% by weight, and the at least one second resin in an amount in the range of 0.1 to 15% by weight, each based on the weight of the ink composition. Although not necessarily limited, it is preferred according to the invention that the total amount of the at least one first resin and the at least one second resin is in the range from 8 to 35% by weight based on the weight of the ink composition from the viewpoint of adhesion of marking that the ink composition provides on the writing surface and the smoothness in writing with the ink composition.

Further according to the invention, the metallic powder pigment ink composition for an oil-based marking pen contains the at least one first resin preferably in an amount in the range of 5 to 25% by weight, and the at least one second resin in an amount in the range of 0.5 to 10% by weight, each based on the weight of the ink composition. Again although not necessarily limited, the total amount of the at least one first resin and the at least one second resin is more preferably in the range of 10 to 30% by weight based on the weight of the ink composition from the viewpoint of adhesion of marking that the ink composition provides on the writing surface and the smoothness in writing with the ink composition.

Examples of the ketone resin used in the invention include, for example, Tego Variplus AP, Tego Variplus SK (manufactured by Evonik), Hirac 111 (manufactured by Hitachi Chemical Company, Ltd.), Ketone Resin K-90 (manufactured by Arakawa Chemical Industries, Ltd.), Polytone K-94, Polytone K-97 (manufactured by Worlee). Examples of the hydrogenated rosin resins include, for example, Ester Gum H, Ester Gum HP (manufactured by Arakawa Chemical Industries, Ltd.). Examples of the ultralight-colored rosin resin include Pine Crystal KE 604 B, Pine Crystal KE 100, Super Ester A-75, Super Ester A-100 (manufactured by Arakawa Chemical Industries, Ltd.). However, the ketone resins used are not limited those mentioned above.

Examples of the acrylic resin include, for example, Hairos Hairos BS-1144, Hairos VS-1029 (manufactured by Seiko PMC Corporation), Dianal. BR-52, Dianal BR-102, Dianal BR-107 (manufactured by Mitsubishi Rayon Co., Ltd.). The styrene-acrylic resins include Hairos X-1, Hairos VS1063, Hairos RS-1191 (manufactured by Seiko PMC Joncryl 67, Joncryl 611, Joncryl 678, Joncryl 682, Joncryl 683, Joncryl 690 (manufactured by BASF). Examples of the styrene-maleic acid resin include, for example, Hairos X-205 (manufactured by Seiko PMC Corporation) and Alastar 700 (Arakawa Chemical Kogyo Co., Ltd.). However, the acrylic resin used in the invention is not limited to those exemplified above.

### (Other Components)

The metallic powder pigment ink composition for an oil-based marking pen of the invention may contain an additive which is usually used in metallic powder pigment ink composition for an oil-based marking pen such as a surface conditioning agent, a thixotropic agent, a pigment dispersant, a wax and the like, if necessary.

### (Production)

Although the metallic powder pigment ink composition for an oil-based marking pen of the invention is not limited at all in the method for production thereof, it is produced by the following method, for example. The at least one first resin and at least one second resin are added to an organic solvent, and if necessary, the resulting is heated, for example, about at 40° C. to dissolve the resins in the organic solvent thereby to prepare a resin solution. After the resin solution is allowed to cool to room temperature, a metallic powder pigment is added to the resin solution. The resulting is stirred, and then other additives are added, and the resulting mixture is further stirred, thereby a metallic powder pigment ink composition for an oil-based marking pen of the invention is obtained.

### EXAMPLES

The invention will be described with reference to examples, but the invention is not limited by these examples at all.

Details of the components used in the following Examples and Comparative Examples are as follows.
Aluminum powder pigment:
   Hydrolac PM Chrom 8 manufactured by Eckart
Brass powder pigment:
   3000 Rich Gold manufactured by Eckart
Organic solvent:
   Propylene glycol monomethyl manufactured by Dow Chemical
Ketone resin:
   Polytone K-94 manufactured by Worlee
Hydrogenated rosin resin:
   Esther Gum H manufactured by Arakawa Chemical Industries, Ltd.
Ultralight-colored Rosin Resin:
   Pine Crystal KB 604 B manufactured by Arakawa Chemical Industries, Ltd.
Acrylic resin:
   Hiros X-310 manufactured by Seiko PMC Corporation
Styrene-acrylic resin
   Hiros X-1 manufactured by Seiko PMC Corporation
Styrene-maleic acid resin:
   Alastar 700 manufactured by Arakawa Chemical Industries, Ltd.
Dispersant:
   Solsperse 24000 manufactured by Lubrizol Corporation

### Example 1

An aluminum powder pigment ink composition was prepared using the components shown in Table 1 each in an amount shown in Table 1. The ink composition was applied to a hiding power chart manufactured by Nippon Test Panel Co., Ltd. using a film applicator provided with a barcoder No. 30 at a speed of 12 cm/sec, dried, and then the glitter of the resulting film or marking was measured using a Horiba Handy Gloss Meter Gloss Checker IG-310 manufactured by Horiba Seisakusho Co., Ltd. in a manner as follows.

The film on the hiding power chart was irradiated with light from a light source at an incident angle of 60°. The reflected light was received by a light receiver provided at a position of a light receiving angle of 60°, and the intensity thereof was measured. Using a glass sheet with a gloss value of 91 as a gloss standard plate, the ratio of the gloss to the intensity of the reflected light was evaluated as glossiness, wherein the reflectance of reflected light on the surface of a glass sheet having a refractive index of 1.567 is 10%, the glossiness is 100.

### Examples 2 to 8

An aluminum powder pigment ink composition was prepared using the components shown in Table 1 each in an amount shown in Table 1 in the same manner as in Example 1, and the glitter of marking that the ink composition provided was measured in the same manner as in Example 1. The results are shown in Table 1.

### Example 9

A brass powder pigment ink composition was prepared using the components shown in Table 1. each in an amount shown in Table 1 in the same manner as in. Example 1, and the glitter of marking that the ink composition provided was measured in the same manner as in Example 1. The results are shown in Table 1.

### Comparative Examples 1 and 2

An aluminum powder pigment ink composition was prepared using the components shown in Table 1 each in an amount shown in Table 1 in the same manner as in Example 1, and the glitter of marking that the ink composition provided was measured in the same manner as in Example 1. The results are shown in Table 1.

### Comparative Example 3

A brass powder pigment ink composition was prepared using the components shown in Table 1 each in an amount shown in Table 1 in the same manner as in Example 1, and the glitter of marking that the ink composition provided was measured in the same manner as in Example 1. The results are shown in Table 1.

TABLE 1

| | Examples | | | | | | | | | Comparative Examples | | |
|---|---|---|---|---|---|---|---|---|---|---|---|---|
| | 1 | 2 | 3 | 4 | 5 | 6 | 7 | 8 | 9 | 1 | 2 | 3 |
| Components of Ink Composition (wt. %) | | | | | | | | | | | | |
| Aluminum powder pigment | 8.0 | 8.0 | 8.0 | 8.0 | 8.0 | 8.0 | 6.0 | 10.0 | | 8.0 | 8.0 | |
| Brass powder pigment | | | | | | | | | 16.0 | | | 16.0 |
| Organic solvent | 74.5 | 76.0 | 73.5 | 63.5 | 71.5 | 81.5 | 73.5 | 73.5 | 64.0 | 73.5 | 83.5 | 64.0 |
| First resin | | | | | | | | | | | | |
| Ketone resin | 12.0 | 15.0 | 15.0 | | | 2.0 | | | 17.0 | 18.0 | | 20.0 |
| Hydrogenated rosin resin | | | | | 10.0 | | 17.0 | | | | | |
| Ultra-light-colored rosin resin | | | | 25.0 | | | | 13.0 | | | | |
| Second resin | | | | | | | | | | | | |
| Acrylic resin | | 0.5 | | 3.0 | | | 3.0 | | | | | |
| Styrene-acrylic resin | 5.0 | | | | 10.0 | | | 3.0 | | | | |
| Styrene-maleic acid resin | | | 3.0 | | | 8.0 | | | 3.0 | | 8.0 | |
| Dispersant | 0.5 | 0.5 | 0.5 | 0.5 | 0.5 | 0.5 | 0.5 | 0.5 | | 0.5 | 0.5 | |
| (Total) | 100.0 | 100.0 | 100.0 | 100.0 | 100.0 | 100.0 | 100.0 | 100.0 | 100.0 | 100.0 | 100.0 | 100.0 |
| Performance of ink composition | | | | | | | | | | | | |
| Glitter | 147 | 73 | 151 | 199 | 199 | 105 | 141 | 107 | 29 | 66 | 66 | 20 |

The metallic powder pigment ink composition for an oil-based marking pen of the invention comprises an organic solvent, an aluminum powder pigment and a combination of the at least one first resin selected from a ketone resin, a hydrogenated rosin resin and an ultralight-colored rosin resin and the at least one second resin selected from an acrylic resin, a styrene-acrylic resin and a styrene-maleic acid resin. Thus, it provides a marking that is much improved in glitter due to synergistic effect of the at least one first resin and the at least one second resin as compared with the metallic powder pigment ink composition of Comparative Examples 1 and 2 in which only one of the at least one first resin and the at least one second resins is incorporated.

Similarly, the metallic powder pigment ink composition for an oil-based marking pen of the invention comprises an organic solvent, a brass powder pigment and a combination of the at least one first resin and the at least one second resin provides a marking which is synergistically improved in glitter as compared with the metallic powder pigment ink composition of Comparative Example 3 in which only one of the at least one first resin and the at least one second resin is incorporated.

1. A metallic powder pigment ink composition for an oil-based marking pen comprising an organic solvent, a metal powder pigment and a resin, wherein the resin is a combination of at least one first resin selected from a ketone resin, a hydrogenated rosin resin and an ultralight-colored rosin resin and at least one second resin selected from a styrene-acrylic resin and a styrene-maleic acid resin.

2. The metallic powder pigment ink composition for an oil-based marking pen oil marking pen according to claim 1, comprising the first resin in an amount in the range of 2 to 30% by weight and the second resin in an amount in the range of 0.1 to 15% by weight, each based on the weight of the ink composition.

3. The metallic powder pigment ink composition for an oil-based marking pen oil marking pen according to claim 1, comprising the first resin in an amount in the range of 5 to 25% by weight and the second resin in an amount in the range of 0.5 to 10% by weight, each based on the weight of the ink composition.

4. The metallic powder pigment ink composition for an oil-based marking pen oil marking pen according to claim 1, wherein the metal powder pigment is an aluminum powder pigment.

5. The metallic powder pigment ink composition for an oil-based marking pen oil marking pen according to claim 1, wherein the organic solvent is at least one selected from an aliphatic alcohol, a glycol, a glycol ether and a glycol ether ester.
